(19) United States
(12) Patent Application Publication
(10) Pub. No.: US 2019/0390093 A1
(43) Pub. Date: Dec. 26, 2019

(54) POLYESTER-BASED RESIN COMPOSITION

(71) Applicant: TOAGOSEI CO., LTD., Tokyo (JP)

(72) Inventors: Takahiro ITO, Nagoya-shi, Aichi (JP); Tatsuya NAKAYASU, West Jefferson, OH (US); Makoto IMAHORI, Nagoya-shi, Aichi (JP)

(73) Assignee: TOAGOSEI CO., LTD., Tokyo (JP)

(21) Appl. No.: 16/084,182

(22) PCT Filed: Mar. 14, 2017
(86) PCT No.: PCT/JP2017/010075

§ 371 Date: Sep. 11, 2018

(30) Foreign Application Priority Data
Mar. 15, 2016 (JP) 2016-050327

(51) Int. Cl. C09J 167/02; C08G 63/672; C08G 63/85; C09J 11/06

(52) U.S. Cl. CPC C09J 167/025; C09J 11/06; C08G 63/85; C08G 63/672

(57) ABSTRACT

The polyester-based resin composition according to the invention is a polyester resin composition, containing: at least a polyester resin (A); and a surfactant (B), in which the polyester resin (A) is a copolymer of a compound having a polyalkylene glycol with from 3 to 50 repeating units as a structure as a constituent component, the surfactant (B) is a nonionic surfactant having a structure of a polyalkylene glycol, and the contact angle of water is 30° or less.

### TECHNICAL FIELD

The present invention relates to a polyester-based adhesive composition having a hydrophilic resin surface without impairing initial adhesive property, and a polyester-based resin composition used therefor.

### BACKGROUND ART

Since polyester resins are excellent in mechanical strength, thermal stability, chemical resistance, and the like, such resins are widely used as coating agents for films or sheets or hot melt adhesives in a variety of fields.

Polyester resins can obtain a variety of structures and properties by appropriately selecting a combination of a polyvalent carboxylic acid and a glycol as the constituent components, and coating films made thereof are excellent in adhesion to a substrate and also excellent in adhesive property to another substrate. Utilizing such excellent adhesion and adhesive property, polyester resins are widely used in applications such as adhesives, coating agents, ink binders, paints, and the like. Examples of the substrate on which a polyester resin is coated generally include a film or a sheet made of a polyester resin, a polycarbonate resin, a polyvinyl chloride resin, or the like, and a foil of a metal such as aluminum or copper.

Meanwhile, there is an attempt to use a polyester resin for both adhesion and coating. Particularly, the method in which a polyester resin is coated on a substrate, another substrate is adhered to a part of the coated portion, and the remaining portion is utilized as it is as a coating film. According to this method, it is unnecessary to precisely adjust the size of an adhesive made of a polyester resin and the size of a substrate to be bonded, which is advantageous.

### RELATED ART DOCUMENTS

### Patent Documents

Patent Document 1 Japanese Patent Application Laid-Open (JP-A) No. 2001-200041

Patent Document 2 JP-A No. S59-66449

### SUMMARY OF INVENTION

### Problems to be Solved by the Invention

Since the surface of a polyester resin generally shows hydrophobicity, surface modification of such a resin is often required for the purpose of improving the hydrophilicity and antistatic property of the resin surface. For the purpose of imparting hydrophilicity to the surface of a resin, a method of copolymerizing and graft polymerizing a hydrophilic monomer such as polyalkylene glycol has been conventionally studied (Patent Document 1). However, improvement of only the surface of a resin is difficult to control in many cases, and since the entire resin is modified, physical properties, adhesive property, and resistance to hydrolysis of the resin are deteriorated, and therefore, such modification is limited. Alternatively, a number of attempts have been made to modify the surface of a resin by adding a surfactant or the like (Patent Document 2). However, a surfactant may be localized on the surface of a resin, and when a polyester resin is used as a polyester resin-based adhesive, the adhesive property is lowered, and therefore, it is difficult to sufficiently modify the resin surface.

An object of the invention is to provide a polyester-based resin composition having hydrophilicity on the surface of a coating film and having a high peel strength with respect to an adherend when used as an adhesive.

### Means for Solving the Problems

In order to solve the above problems, the inventors conducted extensive studies to find that a polyester-based resin composition composed of: a specific polyester resin in which a compound having a polyalkylene glycol as a structure is copolymerized as a constituent; and a nonionic surfactant having a structure of polyalkylene glycol can solve the above-described problems, thereby arriving at the invention.
Specifically, summary of the invention is as follows.
<1>A polyester-based resin composition, containing:
a polyester resin (A); and a surfactant (B), wherein
the polyester resin (A) is a copolymer of a compound having a polyalkylene glycol with from 3 to 50 repeating units as a structure as a constituent component,
the surfactant (B) is a nonionic surfactant having a structure of a polyalkylene glycol, and
the contact angle of water is 30° or less.
<2>The polyester-based resin composition according to <1>, wherein the polyalkylene glycol in the compound having a polyalkylene glycol with from 3 to 50 repeating units as a structure that is a constituent component of the polyester resin (A) has a structure represented by the following Formula (1) or (2).

HO-((CH₂)ₐO)_{b}-H (1)

HO-(CH₂CH((CH₂)_{c}CH₃)O)_{d}-H (2)

(where a: from 2 to 4, c: from 0 to 1, b and d: from 3 to 50)
<3>The polyester-based resin composition according to any one of <1>or <2>, wherein the content of the polyalkylene glycol derived from the compound having a polyalkylene glycol with from 3 to 50 repeating units as a structure which is a constituent component of the polyester resin (A) is from 0.1 to 35% by weight.
<4>The polyester-based resin composition according to any one of <1>to <3>, wherein the number average molecular weight of the polyester resin (A) is from 5,000 to 35,000.
<5>The polyester-based resin composition according to any one of <1>to <4>, wherein the surfactant (B) has a structure represented by the following Formula (3) or (4).

RO-((CH₂)_{c}O)_{f}-H (3)

RO-(CH₂CH((CH₂)_{g}CH₃)O)ₕ-H (4)

(where R represents any one of an alkyl group, an alkenyl group, a cycloalkyl group, a cycloalkenyl group, a cyclic ether group and an aryl group, e: from 2 to 4, g: from 0 to 1, f and h: 2 or more)
<6>The polyester-based resin composition according to any one of <1>to <5>, wherein the content of the surfactant (B) is from 0.1 to 20% by weight.
<7>An adhesive composition obtained by dissolving the polyester-based resin composition according to any one of <1>to <6>in an organic solvent.

### Effects of the Invention

According to the invention, a polyester-based resin composition having a hydrophilic resin surface is obtained. An adhesive obtained from such a polyester-based resin composition has a hydrophilic resin surface and can be used as an adhesive having sufficient adhesion and adhesive property to a resin- or a metal-based sheet or the like.

### DESCRIPTION OF EMBODIMENTS

Hereinafter, the invention will be described in detail.

The polyester-based resin composition according to the present invention is a polyester resin composition, at least containing: a polyester resin (A); and a surfactant (B), wherein the polyester resin (A) is a copolymer of a compound having a polyalkylene glycol with from 3 to 50 repeating units as a structure, the surfactant (B) is a nonionic surfactant having a structure of a polyalkylene glycol, and the contact angle of water is 30° or less.

The polyester resin (A) used in the invention is composed of a polyvalent carboxylic acid component and a polyol component. The polyester resin (A) may be crystalline or amorphous.

It is preferable that a compound having a polyalkylene glycol with from 3 to 50 repeating units as a structure is contained in an amount of from 0.1 to 35% by weight based on 100% by weight of the components constituting the polyester resin (A) since the surface of a coating film obtained from a polyester-based resin composition has favorable hydrophilicity and the adhesive obtained from the same composition has a high adhesive force. The content is more preferably from 0.5 to 15% by weight, and still more preferably from 0.5 to 10% by weight. When the content of the compound having the polyalkylene glycol as a structure is 0.1% by weight or more, the contact angle of water is easily adjusted to 30° or less, and when the content is 35% by weight or less, the physical properties of a polyester-based resin composition to be obtained and the adhesive strength to a substrate are excellent.

When the number of repeating units of a polyalkylene glycol is in the range of from 3 to 50, the adhesive obtained from the polyester-based resin composition has favorable adhesive strength. When the number is less than 3, the adhesive strength is inferior, and when the number exceeds 50, the adhesive strength is inferior.

The polyalkylene glycol in the compound having a polyalkylene glycol with from 3 to 50 repeating units as a structure that is a constituent component of the polyester resin (A) preferably has a structure represented by the following Formula (1) or (2).

HO-((CH₂)ₐO)_{b}-H (1)

HO-(CH₂CH((CH₂)_{c}CH₃)O)_{d}-H (2)

(where a: from 2 to 4, c: from 0 to 1, b and d: from 3 to 50)

With this structure, an effect of improving the hydrophilicity of the surface is increased in a coating film obtained from the polyester-based resin composition.

Examples of the compound having a polyalkylene glycol as a structure which can be used in the invention include polyethylene glycol, polytetramethylene glycol, polypropylene glycol, polyhexylene glycol, polynonanediol, poly (3-methyl-L5-pentane) diol, polyoxyethylene-modified bisphenol A, polyoxypropylene-modified bisphenol A, and polyoxybutylene-modified bisphenol A, and polyethylene glycol is preferable because of a great effect of improving the hydrophilicity of the polyester-based resin composition.

Examples of the polyol component constituting the polyester resin (A) preferably include a glycol component including the polyalkylene glycol.

The glycol component that can be used as a polyol component constituting the polyester resin (A) other than the compound having a polyalkylene glycol as a structure is not particularly limited, and examples thereof include ethylene glycol, diethylene glycol, triethylene glycol, 1,4-butanediol, 1,5-pentanediol, 1,6-hexanediol, 1,7-heptanediol, 1,8-octanediol, 1,9-nonanediol, 1,10-decanediol, 1,12-dodecanediol, 1,4-cyclohexane dimethanol, 1,3-cyclohexane dimethanol, tricyclodecanedimethanol, spiroglycol, dimer diol, neopentyl glycol, 2,2-butylethylpropanediol, 1,2-propanediol, and 2-methyl-1,3-propanediol, 3-methyl-1,5-pentanediol. Among them, 1,6-hexanediol, neopentyl glycol, 2,2-butylethylpropanediol, 1,2-propanediol or 2-methyl-1,3-propanediol is preferably contained from the viewpoint of solvent solubility.

The polyvalent carboxylic acid component constituting the polyester resin (A) is not particularly limited, and it is preferable that the polycarboxylic acid component contains 60% by mole or more of an aromatic dicarboxylic acid as a polyvalent carboxylic acid component. As the aromatic dicarboxylic acid, terephthalic acid is preferable from the viewpoint of initial adhesive property to a substrate and heat resistance, and isophthalic acid is preferable from the viewpoint of solvent solubility.

Examples of polyvalent carboxylic acid components that can be used as a polyvalent carboxylic acid component constituting the polyester resin (A) other than terephthalic acid and isophthalic acid include malonic acid, succinic acid, glutaric acid, adipic acid, pimelic acid, suberic acid, azelaic acid, sebacic acid, undecanedioic acid, dodecanedioic acid, tridecanedioic acid, tetradecanedioic acid, pentadecanedioic acid, hexadecanedioic acid, heptadecanedioic acid, octadecanedioic acid, nonadecanedioic acid, eicosanedioic acid, docosanedioic acid, phthalic acid, naphthalenedicarboxylic acid, 4,4′-dicarboxybiphenyl, 5-sodium sulfoisophthalic acid, 5-hydroxy-isophthalic acid, fumaric acid, maleic acid, itaconic acid, mesaconic acid, citraconic acid, 1,3,4-benzenetricarboxylic acid, 1,2,4,5-benzenetetracarboxylic acid, pyromellitic acid, trimellitic acid, oxalic acid, 1,4-cyclohexanedicarboxylic acid, 1,3 -cyclohexanedicarboxylic acid, 1,2-cyclohexanedicarboxylic acid, 2,5-norbornene dicarboxylic acid, a dimer acid, and a hydrogenated dimer acid, and an anhydride thereof. Among these, from the viewpoint of adhesive property, it is preferable to contain sebacic acid.

In the polyester resin (A) of the invention, a monomer component (other monomer component) other than the polycarboxylic acid component and the glycol component may be used as a monomer constituting the main chain polyester polymer as long as an effect of the invention is not impaired, if necessary. In the polyester polymer, the copolymerization ratio of the other monomer components is preferably less than 50% by mole with respect to the total monomer components contained in the polyester polymer.

Examples of other monomer components include a hydroxycarboxylic acid such as tetrahydrophthalic acid, lactic acid, oxirane, glycolic acid, 2-hydroxybutyric acid, 3-hydroxybutyric acid, 4-hydroxybutyric acid, 2-hydroxyisobutyric acid, 2-hydroxy-2-methylbutyric acid, 2-hydroxyvaleric acid, 3-hydroxyvaleric acid, 4-hydroxyvaleric acid, 5-hydroxyvaleric acid, 6-hydroxycaproic acid, 10-hydroxystearic acid, or 4-(β-hydroxy) ethoxybenzoic acid; and an aliphatic lactone such as β-propiolactone, β-butyrolactone, γ-butyrolactone, δ-valerolactone, or ϵ-caprolactone.

As the other monomer components, monocarboxylic acid, monoalcohol, or the like may be used. Examples of the monocarboxylic acid include lauric acid, myristic acid, palmitic acid, stearic acid, oleic acid, linoleic acid, linolenic acid, benzoic acid, p-tert-butylbenzoic acid, cyclohexanoic acid, and 4-hydroxyphenylstearic acid. Examples of the monoalcohol include octyl alcohol, decyl alcohol, lauryl alcohol, myristyl alcohol, cetyl alcohol, stearyl alcohol, and 2-phenoxyethanol.

Next, a method of producing the polyester resin (A) used in the invention will be described.

First, a monomer combination such as a polybasic carboxylic acid and a glycol is appropriately selected, and such a combination is polymerized by a publicity known polymerization method to obtain a polyester resin (A). More specifically, a polyester resin (A) can be produced by introducing raw material monomers into a reaction vessel, subjecting the mixture to an esterification reaction, and subsequently performing polycondensation until reaching a desired molecular weight by a publicity known method. The esterification reaction is preferably carried out, for example, at a temperature of 180° C. or higher for 4 hours or longer.

Reaction conditions for the polycondensation reaction are not particularly limited, and it is preferable to carry out the reaction using a polymerization catalyst at a temperature of from 220° C. to 280° C. under reduced pressure of 130 Pa or less. Examples of the polymerization catalyst include a titanium compound such as tetrabutyl titanate, an acetate of a metal such as zinc acetate, or magnesium acetate, an organotin compound such as antimony trioxide, hydroxybutyltin oxide, or tin octylate. From the viewpoint of reactivity and color tone of an obtained polyester resin (A), the amount of the polymerization catalyst used is preferably from 0.1 to 20×10⁻⁴ mole per one mole of the acid component.

The number average molecular weight of the polyester resin (A) of the invention is preferably from 5,000 to 35,000 because the solubility of the polyester-based resin composition in an organic solvent is favorable and the adhesive strength of the obtained adhesive composition is large. The number average molecular weight is more preferably from 8,000 to 30,000, and still more preferably from 10,000 to 25,000. When the number average molecular weight is 5,000 or more, the initial adhesive property is excellent. When the number average molecular weight is 35,000 or less, the melt viscosity and solution viscosity of the obtained polyester-based resin composition are appropriate, and the handling property is excellent.

Examples of the method of controlling the molecular weight of the polyester resin (A) in the invention include a method of terminating polymerization at a predetermined melt viscosity of the polyester melt at the time of polycondensation, a method of once producing a polyester having a high molecular weight and then adding a depolymerizing agent, and further, a method of adding a monofunctional carboxylic acid or monofunctional alcohol in advance. In the invention, the molecular weight may be controlled by any of the methods described above.

The surfactant (B) used in the invention is a nonionic surfactant having a polyalkylene glycol structure.

The surfactant (B) is preferably one having a structure represented by the following Formula (3) or (4).

RO-((CH₂)ₑO)_{f}-H (3)

RO-(CH₂CH((CH₂)_{g}CH₃)O)ₕ-H (4)

(where R represents any one of an alkyl group, an alkenyl group, a cycloalkyl group, a cycloalkenyl group, a cyclic ether group, and an aryl group, e: from 2 to 4, g: from 0 to 1, f and h: 2 or more)

This structure increases a hydrophilicity improving effect of the surface of a coating film obtained from the polyester-based resin composition.

The HLB of the surfactant (B) is preferably from 8 to 20, because the hydrophilicity of the polyester resin composition and the adhesive strength of an adhesive obtained from the polyester-based resin composition are favorable. When the HLB is 8 or more, the surface of the coating film obtained from the polyester-based resin composition is excellent in hydrophilicity, and when the HLB is 20 or less, an obtained adhesive composition is excellent in the adhesive strength.

As the surfactant (B), a polyoxyethylene higher alcohol ether such as polyoxyethylene lauryl alcohol, polyoxyethylene lauryl ether, or polyoxyethylene oleyl ether, a polyoxyethylene alkylaryl ether such as polyoxyethylene octylphenol or polyoxyethylene nonylphenol, a polyoxyethylene acyl ester such as polyoxyethylene glycol monostearate, a polypropylene glycol ethylene oxide adduct, a polyoxyethylene sorbitan fatty acid ester such as polyoxyethylene sorbitan monolaurate or polyoxyethylene sorbitan monostearate, a phosphate ester such as alkyl phosphate ester or a polyoxyethylene alkyl ether phosphate ester, a sugar ester, a cellulose ether, or the like is used.

Since the hydrophilicity of the surface of a coating film obtained from the polyester-based resin composition is large and the adhesion to a substrate is enhanced, the content of the surfactant (B) used in the invention is preferably from 0.1 to 20% by weight based on the polyester-based resin composition. The content is more preferably from 0.3 to 15% by weight, and even more preferably from 0.5 to 8.0% by weight. When the addition amount is 0.1% by weight or more, hydrophilicity is excellent on the surface of the polyester-based resin composition, and when the addition amount is 20% by weight or less, bleeding of the resin surface and adhesion of the resin composition are excellent.

The polyester resin composition of the invention may be crystalline or amorphous. Crystallinity means that a composition has a crystal melting point (hereinafter, referred to as melting point) at elevated temperature and a heat of fusion of 0.1 J/g or more when measured according to JIS K 7121 using DSC (differential scanning calorimeter), and amorphous means that a composition does not have a crystal melting point and has a heat of fusion of less than 0.1 J/g.

Examples of the method of producing the polyester-based resin composition include [1] a method in which predetermined amounts of (A) and (B) are collectively dissolved in an organic solvent, [2] a method in which an organic solvent solution in which (A) has previously been dissolved and an organic solvent solution in which (B) has been dissolved are mixed, and [3] a method in which (A) and (B) are once melt-kneaded and then the resultant resin composition is dissolved in an organic solvent, and [1] is preferable. The organic solvent is not particularly limited, and examples thereof include an aromatic solvent such as toluene, xylene, solvent naphtha, or SOLVESSO; a ketone solvent such as methyl ethyl ketone, methyl isobutyl ketone, or cyclohexanone; an alcohol solvent such as methyl alcohol, ethyl alcohol, isopropyl alcohol, or isobutyl alcohol; an ester solvent such as ethyl acetate or normal butyl acetate; and an acetate solvent such as cellosolve acetate or methoxy acetate. These solvents may be used singly or in combination of two or more kinds thereof

The polyester-based resin composition of the invention has a water contact angle of 30° or less. The contact angle of water is measured by the method described below, and when the contact angle exceeds 30° , the wettability to water or an aqueous liquid is insufficient and the wettability of water or an aqueous liquid on a coating film of the polyester-based resin composition is insufficient, which is not preferable.

As described above, the adhesive composition of the invention is obtainable by mixing the polyester resin (A) and the surfactant (B), and dissolving the mixture in an organic solvent.

In other words, the adhesive composition of the invention is prepared by dissolving the polyester-based resin composition of the invention in an organic solvent.

Since the handling is easy and the thickness of a coating film is appropriate, the solid content concentration of the adhesive composition is preferably from 5 to 60% by weight. The solid content concentration is more preferably from 10 to 50% by weight, and still more preferably from 20 to 40% by weight. When the solid content concentration is 5% by weight or more, it is easy to apply a sufficient amount of an adhesive when a substrate is coated with the adhesive as described below. On the other hand, when the solid content concentration is 60% by weight or less, the solution viscosity of an adhesive is appropriate, and when a substrate is coated with the adhesive, the thickness precision is excellent.

To the polyester-based resin composition of the invention or the adhesive composition of the invention, an antioxidant, a hydrolysis inhibitor, a pigment, or the like can be added, if necessary. The antioxidant is not particularly limited, and examples thereof include a phenol type antioxidant, a phosphorus type antioxidant, and a sulfur type antioxidant. Examples of the hydrolysis inhibitor include an isocyanate-derived carbodiimide. Examples of the pigment include titanium dioxide, and zinc oxide.

A substrate with an adhesive in which a film is formed on the substrate, in particular, a sheet or film with an adhesive can be produced by, for example, coating the polyester-based resin composition of the invention or the adhesive composition of the invention on a variety of substrates, and if necessary drying and removing an organic solvent.

The substrate to be coated with the polyester-based resin composition of the invention or the adhesive composition of the invention is not particularly limited, and examples thereof include a polyester substrate selected from polyethylene terephthalate (PET), polyethylene naphthalate (PEN), polybutylene terephthalate (PBT), or polycyclohexane dimethanol-terephthalate (PCT), a polycarbonate substrate, a fluorine substrate selected from polyvinyl fluoride (PVF), polyvinylidene fluoride (PVDF), polychlorotrifluoroethylene (PCTFE), polyethylene tetrafluoroethylene (ETFE), polytetrafluoroethylene (PTFE), tetrafluoroethylene perfluoroalkyl vinyl ether copolymer (PFA), or tetrafluoroethylene-hexafluoropropylene copolymer (FEP), or an acrylic substrate, a polyolefin substrate such as a cyclic olefin (COC), a polyethylene (high density polyethylene, low density polyethylene, linear low density polyethylene), polypropylene, or polybutene, a polyvinyl chloride substrate, a polystyrene substrate, a polyvinylidene chloride substrate, an ethylene-vinyl acetate copolymer substrate, a polyvinyl alcohol substrate, a polyvinyl acetate substrate, an acetal substrate, a polyamide substrate, and a polyarylate substrate. A plurality of substrates and adhesive layers may be present, and a layered body can be formed. When a plurality of substrates are used, the substrates may be the same or different from each other.

The method of coating the polyester-based resin composition of the invention or the adhesive composition of the invention on a substrate is not particularly limited, and a publicity known method such as a reverse roll coating method, a gravure coating method, a die coating method, a comma coating method, or a spray coating method can be used.

When a substrate is coated with the polyester-based resin composition of the invention or the adhesive composition of the invention, the thickness of a coating film to be formed varies depending on the intended use, and is preferably from 3 to 1,000 μm, more preferably from 5 to 500 μm, and still more preferably from 5 to 300 μm. When the thickness of the coating film is 3 μm or more, needed adhesive property can be sufficiently obtained. On the other hand, when the thickness is 1,000 μm or less, it is economical and excellent in adhesive property.

The adhesive composition of the invention has properties of a polyester resin-based adhesive, is excellent in adhesive property to a metal or resin material and mechanical properties, and the contact angle of water on the resin surface is 30° or less, and the resin surface exposed without being adhered maintains a state of favorable wettability to water. Such properties are suitably used as a hot melt adhesive having favorable ink transferability, such as when printing on a portion of an adhesive layer.

### EXAMPLES

The invention will be specifically described based on Examples and Comparative Examples, but the invention is not limited thereto.

### 1. Evaluation Method

### 1-1. Contact Angle

The contact angle of water was measured at 25° C. by the sessile drop method prescribed in JIS R 3257 (established in 1999). A contact angle measurement apparatus used is a CA-X type contact angle meter manufactured by Kyowa Interface Science Co., Ltd.

### 1-2. Number Average Molecular Weight

Apparatus: HLC-8220GPC (manufactured by TOSOH CORPORATION)
Column: TSKgel GMHXL×2 (manufactured by TOSOH CORPORATION)
Column temperature: 40° C.
Eluent: tetrahydrofuran 1.00 mL/min.
Detector: RI (differential refractometer)
The molecular weight measured by GPC was converted based on the molecular weight of polystyrene.

### 1-3. Monomer Composition of Polyester Resin

¹H-NMR was measured using an NMR measuring apparatus, and the resin composition was determined from the peak intensity of each copolymerization component. As a measurement solvent, deuterated chloroform was used.

### 1-4. Melting Point, Glass Transition Point

The measurement was carried out with a differential scanning calorimeter (DSC). The programming rate was 10° C./min.

### 1-5. Stability Test of Adhesive Composition

70 g of an adhesive composition was placed in a 100 mL glass bottle, and the bottle was sealed tightly. After standing at 5° C. for 7 days, visual evaluation was performed according to the following criteria.

A: The composition remained liquid. B: The composition solidified in an agar state and returned to a liquid state at 25° C. C: The composition solidified in an agar state and did not return to a liquid state at 25° C.

### 1-6. Peel Strength

### (1) Preparation of Test Pieces

An aluminum foil (100 mm×200 mm) having a thickness of 40 μm was coated with an adhesive composition with a bar coater, and then, dried at 100° C. for 3 minutes to remove an organic solvent contained in the adhesive composition to form an adhesive layer having a thickness of 30 μm. Subsequently, a PET film having a thickness of 100 μm was laminated on the surface of the adhesive layer, and the film was pressure bonded from the surface of the aluminum foil using a thermal gradient tester to obtain a test piece. The bonding conditions at this time were a temperature of 100° C., a pressure of 0.3 MPa, and a pressing time of 2 seconds.

### (2) Measurement of T Peel Strength

The test piece was cut into a width of 10 mm, and the T peel strength (N/10 mm) between an aluminum foil and PET was measured. The measurement conditions are a temperature of 25° C. and a pulling rate of 100 mm/min.

2. Raw Materials

(1) Surfactant

(S-1): Polyoxyethylene lauryl ether (“EMULGEN 103” manufactured by Kao Corporation), HLB 8.1)
(S-2): Polyoxyethylene sorbitan monolaurate (“RHEODOL TW-L106” manufactured by Kao Corporation, HLB 13.3″
(S-3): Coconut amine acetate (“ACETAMIN 24” manufactured by Kao Corporation)
(S-4): Sodium dodecylbenzenesulfonate (“NEOPEREX G-65” manufactured by Kao Corporation)

### (Synthesis of Polyester Resin)

### Synthesis Example 1

As shown in Table 1, 159 parts by weight of terephthalic acid, 52.9 parts by weight of isophthalic acid, 65.9 parts by weight of sebacic acid, 91.1 parts by weight of ethylene glycol, 92.5 parts by weight of 1,6-hexanediol, 39.1 parts by weight of PEG 200, and 0.3 parts by weight of tetrabutyl titanate as a polymerization catalyst were charged into a reactor, and the interior of the system was replaced with nitrogen. Thereafter, while stirring these raw materials at 300 rpm, the reactor was heated at 230° C. and the mixture was melted. After the temperature in the reactor reached 230° C., an esterification reaction was allowed to proceed for 3 hours. After 3 hours, the temperature in the system was brought to 240° C., and the pressure in the system was reduced. After the inside of the system reached a high vacuum (pressure: from 0.1 to 10⁻⁵ Pa), a polymerization reaction was further performed for 5 hours to obtain a polyester resin (P-1). The polyester resin (P-1) had a number average molecular weight of 19,000, a melting point of 68° C., and a glass transition point of −3° C. The results are shown in Table 2. The content of polyalkylene glycol was determined by NMR measurement of the obtained polyester resin.

TABLE 1

| | | Synthesis | Synthesis | Synthesis | Synthesis | Synthesis | Synthesis | Synthesis | Synthesis | Synthesis | Synthesis |
|---|---|---|---|---|---|---|---|---|---|---|---|
| | | Example | Example | Example | Example | Example | Example | Example | Example | Example | Example |
| Raw material name | | 1 | 2 | 3 | 4 | 5 | 6 | 7 | 8 | 9 | 10 |
| Charged | EG | 91.1 | 94.0 | 93.6 | 87.3 | 84.3 | 81.5 | 86.9 | 86.4 | 85.8 | 94.1 |
| com- | HG | 92.5 | 119 | 115 | 59.1 | 32.1 | 6.9 | 105 | 107 | 107 | 119 |
| position | PEG200 | 39.1 | 0.3 | 6.7 | 87.6 | 127 | 163 | | | | |
| (weight) | PEG1000 | | | | | | | 43.5 | | | |
| | PEG2000 | | | | | | | | 43.3 | | |
| | PEG3000 | | | | | | | | | 46.1 | |
| | TPA | 159 | 164 | 163 | 152 | 147 | 142 | 151 | 150 | 149 | 164 |
| | IPA | 52.9 | 54.6 | 54.3 | 50.7 | 48.9 | 47.3 | 50.4 | 50.1 | 49.8 | 54.6 |
| | SEA | 65.9 | 68.1 | 67.7 | 63.2 | 61.1 | 59.0 | 62.9 | 62.6 | 62.1 | 68.1 |
| | Tetrabutyl titanate | 0.3 | 0.3 | 0.3 | 0.3 | 0.3 | 0.3 | 0.3 | 0.3 | 0.3 | 0.3 |

TABLE 2

| | | Synthesis | Synthesis | Synthesis | Synthesis | Synthesis | Synthesis | Synthesis | Synthesis | Synthesis | Synthesis |
|---|---|---|---|---|---|---|---|---|---|---|---|
| | | Example | Example | Example | Example | Example | Example | Example | Example | Example | Example |
| | | 1 | 2 | 3 | 4 | 5 | 6 | 7 | 8 | 9 | 10 |
| Resin name | | P-1 | P-2 | P-3 | P-4 | P-5 | P-6 | P-7 | P-8 | P-9 | P-10 |
| Compoisition | EG | 20 | 20 | 20 | 20 | 20 | 20 | 20 | 20 | 20 | 20 |
| (mol %) | HG | 24 | 30 | 29 | 16 | 9 | 2 | 29 | 29 | 30 | 30 |
| | PEG200 | 6.0 | 0.05 | 1.0 | 14 | 21 | 28 | | | | |
| | PEG1000 | | | | | | | 1.4 | | | |
| | PEG2000 | | | | | | | | 0.7 | | |
| | PEG3000 | | | | | | | | | 0.5 | |
| | TPA | 30 | 30 | 30 | 30 | 30 | 30 | 30 | 30 | 30 | 30 |
| | IPA | 10 | 10 | 10 | 10 | 10 | 10 | 10 | 10 | 10 | 10 |
| | SEA | 10 | 10 | 10 | 10 | 10 | 10 | 10 | 10 | 10 | 10 |

| | | | | | | | | | | |
|---|---|---|---|---|---|---|---|---|---|---|
| Polyalkylene glycol | 9.8 | 0.1 | 1.7 | 21 | 31 | 39 | 11 | 11 | 11 | |
| content (% by weight) | | | | | | | | | | |
| Number average | 19,000 | 20,000 | 19,500 | 19,000 | 20,100 | 21,000 | 20,000 | 19,000 | 19,000 | 20,000 |
| molecular weight | | | | | | | | | | |
| Melting point (° C.) | 68.0 | 70.0 | 68.0 | 72 | 60 | 58 | 68 | 68 | 68 | 70.0 |
| Glass transition point (° C.) | −3.0 | −1.0 | −2.0 | −20 | −22 | −25 | −8 | −8 | −8 | 1.0 |

### Synthesis Examples 2 to 10

Polycondensation of a polyester resin was carried out in the same manner as in Synthesis Example 1 except that the type of monomer used and the charge composition thereof were changed as shown in Table 1. The physical properties of the obtained polyester resin are shown in Table 2.

Abbreviations in Table 1 and Table 2 described below are as follows.
TPA: Terephthalic acid
IPA: Isophthalic acid
SEA: Sebacic acid
EG: Ethylene glycol
HG: 1,6-hexane diol
PEG200: Polyethylene glycol (molecular weight: 200, repeating units: about 4.6)
PEG1000: Polyethylene glycol (molecular weight: 1,000, repeating units: about 23)
PEG2000: Polyethylene glycol (molecular weight: 2,000, repeating units: about 45)
PEG3000: Polyethylene glycol (molecular weight: 3,000, repeating units: about 68)

The final resin compositions and characteristic values of the obtained polyester resins (P-1) to (P-10) are shown in Table 2.

### Example 1

100 parts by weight of the polyester resin (P-1) synthesized in Synthesis Example 1 and 0.1 parts by weight of the surfactant (S-1) were dissolved in 125 parts by weight of toluene and 125 parts by weight of methyl ethyl ketone to obtain an adhesive having a solid content concentration of 29% by weight. Various evaluations were performed using the obtained adhesive. The results are shown in Table 3.

### Examples 2 TO 12, and Comparative Examples 1 TO 5

An adhesive was obtained in the same manner as in Example 1 except that the types and amounts of the polyester resin and surfactant were changed as shown in Table 3 and Table 4 and various evaluations were performed. The results are shown in Tables 3 and 4.

TABLE 3

| | | Example | Example | Example | Example | Example | Example | Example | Example | Example | Example | Example | Example |
|---|---|---|---|---|---|---|---|---|---|---|---|---|---|
| | | 1 | 2 | 3 | 4 | 5 | 6 | 7 | 8 | 9 | 10 | 11 | 12 |
| Polyester | Synthesis | 100 | 100 | 100 | 100 | 100 | | | | | | | |
| resin | Example 1 | | | | | | | | | | | | |
| | (P-1) | | | | | | | | | | | | |
| | Synthesis | | | | | | 100 | | | | | | |
| | Example 2 | | | | | | | | | | | | |
| | (P-2) | | | | | | | | | | | | |
| | Synthesis | | | | | | | 100 | | | | | |
| | Example 3 | | | | | | | | | | | | |
| | (P-3) | | | | | | | | | | | | |
| | Synthesis | | | | | | | | 100 | | | | |
| | Example 4 | | | | | | | | | | | | |
| | (P-4) | | | | | | | | | | | | |
| | Synthesis | | | | | | | | | 100 | | | |
| | Example 5 | | | | | | | | | | | | |
| | (P-5) | | | | | | | | | | | | |
| | Synthesis | | | | | | | | | | 100 | | |
| | Example 6 | | | | | | | | | | | | |
| | (P-6) | | | | | | | | | | | | |
| | Synthesis | | | | | | | | | | | 100 | |
| | Example 7 | | | | | | | | | | | | |
| | (P-7) | | | | | | | | | | | | |
| | Synthesis | | | | | | | | | | | | 100 |
| | Example 8 | | | | | | | | | | | | |
| | (P-8) | | | | | | | | | | | | |
| Surfactant | (S-1) | 0.1 | 5.0 | 10.0 | 15.0 | | 5.0 | 5.0 | 5.0 | 5.0 | 5.0 | 5.0 | 5.0 |
| | (S-2) | | | | | 5.0 | | | | | | | |
| Organic | toluene | 125 | 125 | 125 | 125 | 125 | 125 | 125 | 125 | 125 | 125 | 125 | 125 |
| solvent | methyl ethyl | 125 | 125 | 125 | 125 | 125 | 125 | 125 | 125 | 125 | 125 | 125 | 125 |
| | keetone | | | | | | | | | | | | |

| | | | | | | | | | | | | |
|---|---|---|---|---|---|---|---|---|---|---|---|---|
| Solution appearance | A | A | A | A | A | A | A | A | A | A | A | A |
| Contact angle (water, | 20 | 10 | 5 | 5 | 10 | 10 | 10 | 10 | 10 | 5 | 10 | 10 |
| 25° C.) | | | | | | | | | | | | |
| Peel strength (N/10 mm) | 24 | 22 | 20 | 10 | 22 | 20 | 20 | 22 | 20 | 10 | 22 | 22 |

TABLE 4

| | | Comparative | Comparative | Comparative | Comparative | Comparative |
|---|---|---|---|---|---|---|
| | | Example 1 | Example 2 | Example 3 | Example 4 | Example 5 |
| Polyester | Synthesis | 100 | 100 | 100 | | |
| resin | Example 1 | | | | | |
| | (P-1) | | | | | |
| | Synthesis | | | | 100 | |
| | Example 9 | | | | | |
| | (P-9) | | | | | |
| | Synthesis | | | | | 100 |
| | Example 10 | | | | | |
| | (P-10) | | | | | |
| Surfactant | (S-1) | | | | 5.0 | 5.0 |
| | (S-3) | | 5.0 | | | |
| | (S-4) | | | 5.0 | | |
| Organic | Toluene | 125 | 125 | 125 | 125 | 125 |
| solvent | Methyl | 125 | 125 | 125 | 125 | 125 |
| | ethyl | | | | | |
| | ketone | | | | | |

| | | | | | |
|---|---|---|---|---|---|
| Solution appearance | A | A | A | A | A |
| Contact angle | 65 | 70 | 5 | 5 | 5 |
| (water, 25° C.) | | | | | |
| Peel strength | 24 | 24 | 8 | 7 | 5 |
| (N/10 mm) | | | | | |

According to the results of Table 3, the adhesive compositions of Examples 1 to 12 had a contact angle of water of 30° or less, a peel strength as high as 10 N/10 mm or higher, and it was possible to obtain a polyester resin-based adhesive composition having both wettability against water and peel strength and the stability of an adhesive solution was also favorable.

In Comparative Example 1, the peel strength was 24 N/10 mm, which was favorable, but since the surfactant described in claim 1 was not contained, the contact angle of water was 65°.

In Comparative Example 2, the peel strength was 24 N/10 mm, which was favorable, but since the surfactant contained was not a nonionic surfactant having a polyalkylene glycol structure, the contact angle of water was 70°.

In Comparative Example 3, the contact angle of water was 5°, but since the surfactant contained was not a nonionic surfactant having a polyalkylene glycol structure, the peel strength was 8 N/10 mm.

In Comparative Example 4, the contact angle of water was 5°, but since the number of repeating units of a polyalkylene glycol copolymerized in the polyester resin exceeded the range shown in claim 1, the peel strength was 7 N/10 mm.

In Comparative Example 5, the contact angle of water was 5°, but since a polyalkylene glycol was not copolymerized in the polyester resin, the peel strength was 5 N/10 mm.

### INDUSTRIAL APPLICABILITY

The adhesive composition of the invention has properties of a polyester resin-based adhesive, is excellent in adhesion to a metal or resin material and mechanical properties, and the contact angle of water on the resin surface is 30° or less, and the resin surface exposed without being adhered maintains a state of favorable wettability to water. Such properties are suitably used as a hot melt adhesive having favorable ink transferability, such as when printing on a portion of an adhesive layer.

1. A polyester-based resin composition, comprising:
a polyester resin (A); and a surfactant (B), wherein
the polyester resin (A) is a copolymer of a compound having a polyalkylene glycol with from 3 to 50 repeating units as a structure as a constituent component,
the surfactant (B) is a nonionic surfactant having a structure of a polyalkylene glycol, and the contact angle of water is 30° or less.

2. The polyester-based resin composition according to claim 1, wherein the polyalkylene glycol in the compound having a polyalkylene glycol with from 3 to 50 repeating units as a structure that is a constituent component of the polyester resin (A) has a structure represented by the following Formula (1) or (2).
HO-((CH₂)ₐO)_{b}-H (1)
HO-(CH₂CH((CH₂)_{c}CH₃)O)_{d}-H (2)
(where a: from 2 to 4, c: from 0 to 1, b and d: from 3 to 50)

3. The polyester-based resin composition according to claim 1, wherein the content of the polyalkylene glycol derived from the compound having a polyalkylene glycol with from 3 to 50 repeating units as a structure which is a constituent component of the polyester resin (A) is from 0.1 to 35% by weight.

4. The polyester-based resin composition according to claim 1, wherein the number average molecular weight of the polyester resin (A) is from 5,000 to 35,000.

5. The polyester-based resin composition according to claim 1, wherein the surfactant (B) has a structure represented by the following Formula (3) or (4).
RO-((CH₂)ₑO)_{f}-H (3)
RO-(CH₂CH((CH₂)_{g}CH₃)O)ₕ-H (4)
(where R represents any one of an alkyl group, an alkenyl group, a cycloalkyl group, a cycloalkenyl group, a cyclic ether group and an aryl group, e: from 2 to 4, g: from 0 to 1, f and h:
2 or more)

6. The polyester-based resin composition according to claim 1, wherein the content of the surfactant (B) is from 0.1 to 20% by weight.

7. An adhesive composition obtained by dissolving the polyester-based resin composition according to claim 1 in an organic solvent.
